(19) United States
(12) Patent Application Publication
(10) Pub. No.: US 2013/0322069 A1
(43) Pub. Date: Dec. 5, 2013

(54) LAMP STRUCTURE

(71) Applicants: CHIH-MING LIAO, TAOYUAN COUNTY (TW); CHIH SUNG CHEN, NEW TAIPEI CITY (TW); CHI-FU CHUANG, NEW TAIPEI CITY (TW); JIH-SHENG HUANG, TAOYUAN COUNTY (TW)

(72) Inventors: CHIH-MING LIAO, TAOYUAN COUNTY (TW); CHIH SUNG CHEN, NEW TAIPEI CITY (TW); CHI-FU CHUANG, NEW TAIPEI CITY (TW); JIH-SHENG HUANG, TAOYUAN COUNTY (TW)

(73) Assignee: ENLIGHT CORPORATION, TAOYUAN COUNTY (TW)

(21) Appl. No.: 13/597,782

(22) Filed: Aug. 29, 2012

(30) Foreign Application Priority Data
Jun. 4, 2012 (TW) 101210709

(51) Int. Cl. F21V 13/10; F21V 21/00

(52) U.S. Cl. 362/235; 362/249.01

(57) ABSTRACT

A lamp structure includes a lamp housing, a light-guiding module, a light source module, and a fastening piece. The lamp housing includes a bottom wall and an annular side wall, where the side wall connects to the bottom wall to define a receiving space. The bottom wall has a positioning portion. The light-guiding module is disposed in the receiving space surrounded by the light source module. The light source module includes a circuit board and a plurality of light source units. The circuit board includes a projection portion engaging with the positioning portion. The fastening piece includes a fastening portion releasably attached to the lamp housing to provide structural stability.

### BACKGROUND

1. Field of the Invention

The instant disclosure relates to a lamp structure; in particular, to enable rapid disassembly.

2. Description of Related Art

Traditional lamps use tungsten bulbs or fluorescent tubes as illumination sources. In addition to the high power consumption, heat, and manufacturing cost, the glare can make the users' eyes uncomfortable.

Technological advancement has made light emitting diodes (LEDs) as a popular light source for illumination in lighting applications. LEDs do not blink and have the advantages of low power consumption, high brightness, long life time, and no mercury. Thus LEDs are gradually replacing traditional light sources.

The instant disclosure utilizes the LED as the light source in providing an improved lamp structure having excellent structural characteristics.

### SUMMARY OF THE INVENTION

The object of the instant disclosure is to provide a lamp structure having improved structural characteristics in achieving excellent structural stability.

The lamp structure comprises a lamp housing, a light-guiding module, a light source module, and a fastening piece. The lamp housing includes a bottom wall and an annular side wall. The side wall connects to the bottom wall and cooperatively defines a receiving space. The bottom wall has a positioning portion. The light-guiding module is disposed in the receiving space. The light source module is disposed around the light-guiding module. The light source module includes a circuit board and a plurality of light source units spacingly disposed thereon. The circuit board has a projection engageable with the positioning portion of the bottom wall. The fastening piece has a fastening portion that removably engages with the lamp housing.

In summary, the lamp structure provides strong structural stability by utilizing the positioning portion as well as the projection portion. Also, the lamp structure provides excellent illumination quality.

In order to further understand the instant disclosure, the following embodiments are provided along with illustrations to facilitate the appreciation of the instant disclosure; however, the appended drawings are merely provided for reference and illustration, without any intention to be used for limiting the scope of the instant disclosure.

### BRIEF DESCRIPTION OF THE DRAWINGS

FIG. 1 is a perspective view of a lamp structure for a first embodiment of the instant disclosure.

FIG. 2 is a perspective view of the lamp structure in FIG. 1 from a different angle.

FIG. 3 is an exploded view of the lamp structure in FIG. 1.

FIG. 4 is a cross-sectional view of the assembled lamp housing, light-source module, and the fastening piece.

FIG. 5 is a cross-sectional view of the lamp structure in FIG. 1.

FIG. 6 is an enlarged view of region A in FIG. 5.

FIG. 7 is a schematic view showing the light emitting paths of the lamp structure in FIG. 1.

FIG. 8 is an exploded view of a lamp structure for a second embodiment of the instant disclosure.

FIG. 9 is a top view of the lamp structure in FIG. 8.

### DETAILED DESCRIPTION OF THE PREFERRED EMBODIMENTS

When reference is made to the number of elements or the like in the following description of the embodiments, the number is not limited to a specific number unless otherwise specified.

### First Embodiment

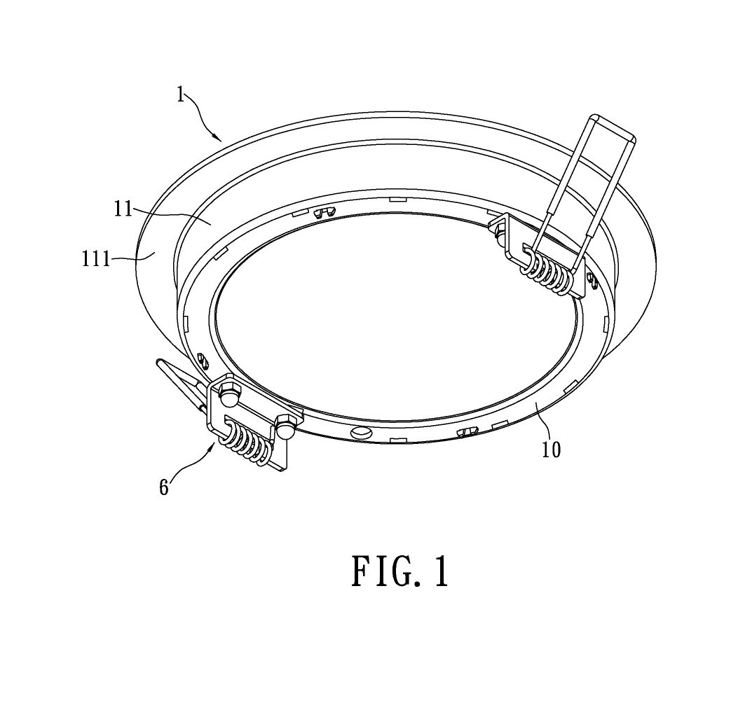

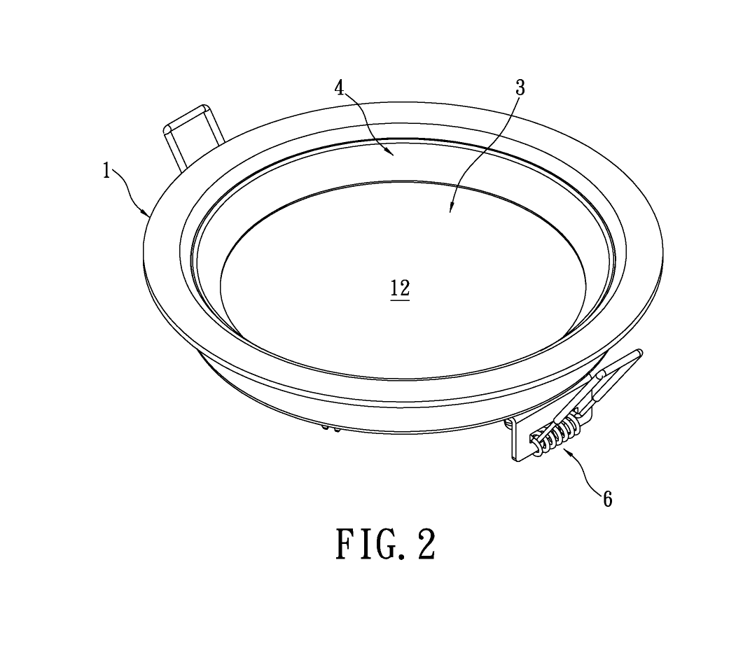

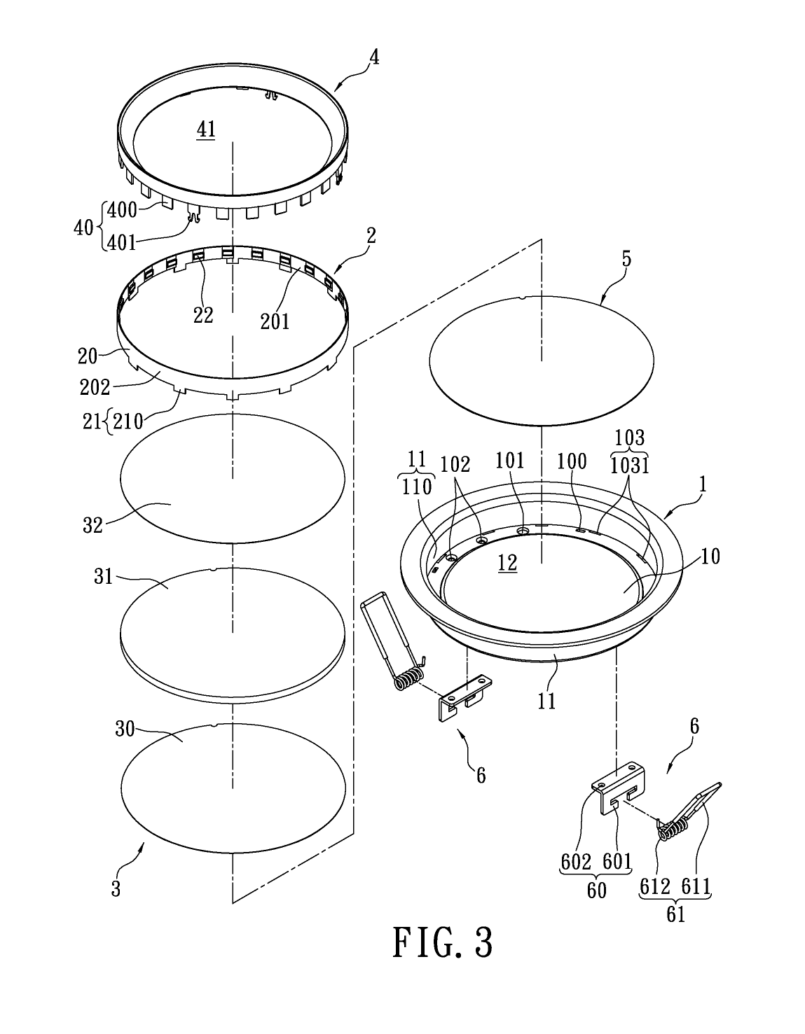

Please refer to FIGS. 1˜3. FIG. 1 is a perspective view showing a lamp structure of the instant disclosure. FIG. 2 is a perspective view of the lamp structure from a different angle. Whereas FIG. 3 is an exploded view of the lamp structure.

The lamp structure of the instant disclosure is structurally stable and emits light laterally. The lamp structure comprises a lamp housing 1, a light source module 2, a light-guiding module 3, a fastening piece 4, a board 5, and at least one connecting piece 6.

The lamp housing 1 has a bottom wall 10 and an annular side wall 11. The side wall 11 bendably extends from the edge of the bottom wall 10 and cooperatively defines a receiving space 12. The lamp housing 1 is substantially pot-shaped as a conductor for heat dissipation as well as fixing the light source module 2. Nevertheless, the shape of the lamp housing 1 is not restricted. For example, the lamp housing 1 may be square shaped or polygonal.

Four receiving holes 100, a wiring hole 101, and four attachment holes 102 are formed and spaced circumferentially on the bottom wall 10. Also, the bottom wall 10 has a positioning portion 103; the positioning portion 103 has a plurality of assembly slots 1031 penetrating the bottom wall 10. The positions of the receiving hole 100, wiring hole 101, attachment holes 102 and assembly slots 1031 do not overlap one another.

The assembly slots 1031 of the positioning portion 103 are intervally spaced on the bottom wall 10 and adjacent to the side wall 11. The walls that define each assembly slot 1031 is rectangular in shape. Each of the assembly slots 1031 is substantially the same in shape and size. However, the assembly slots 1031 can also be configured as blind holes; that is to say the assembly slots 1031 do not penetrate through the bottom wall 10.

The side wall 11 has a contacting face 110 and a fold 111 and surrounds the edge of the bottom wall 10. The contacting face 110 is a flat surface of the inner side of the side wall 11. The fold 111 is formed by bending and extending one edge of the side wall 11 away from the bottom wall 10 to increase the surface area for heat dissipation.

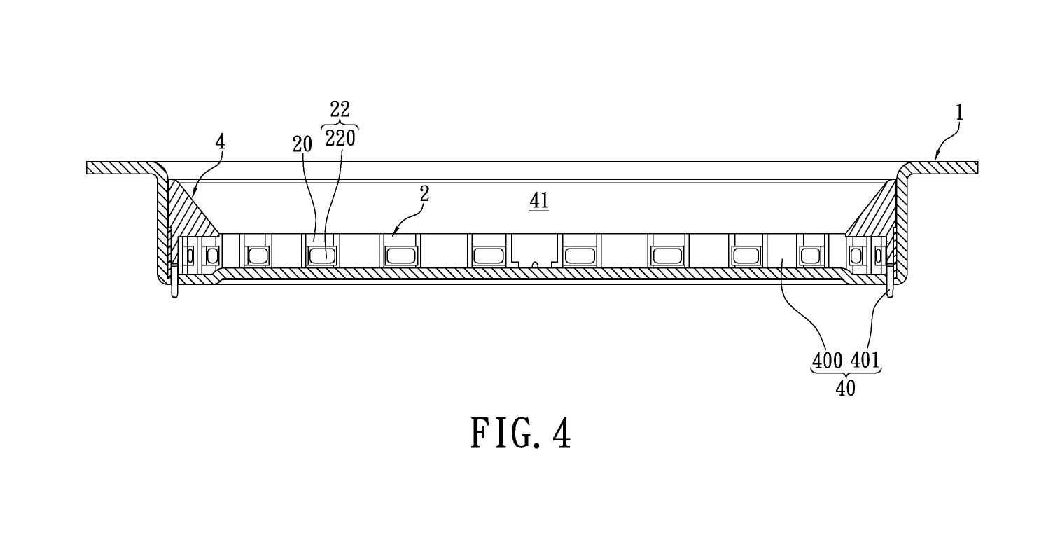

Please refer to FIG. 4 in conjunction with FIG. 3. FIG. 4 is the side cross-sectional view of the assembled lamp housing 1, the light source module 2, and the fastening piece 4. The light source module 2 is disposed in the receiving space 12 of the lamp housing 1. The light source module 2 includes a circuit board 20 and a plurality of light source units 22. The circuit board 20 is strip-like and annular in shape. The light source units 22 are arranged and spaced at equal intervals on the circuit board 20 and electronically connected thereto.

The circuit board 20 has an inner face 201 and an outer face 202. The annular circuit board 20 is formed by connecting opposite ends thereof. The light source units 22 are disposed on the inner face 201 and hence emitting light towards the receiving space 12. In the illustrated embodiment, light emitting diodes (LEDs) 220 are utilized as the light source units 22.

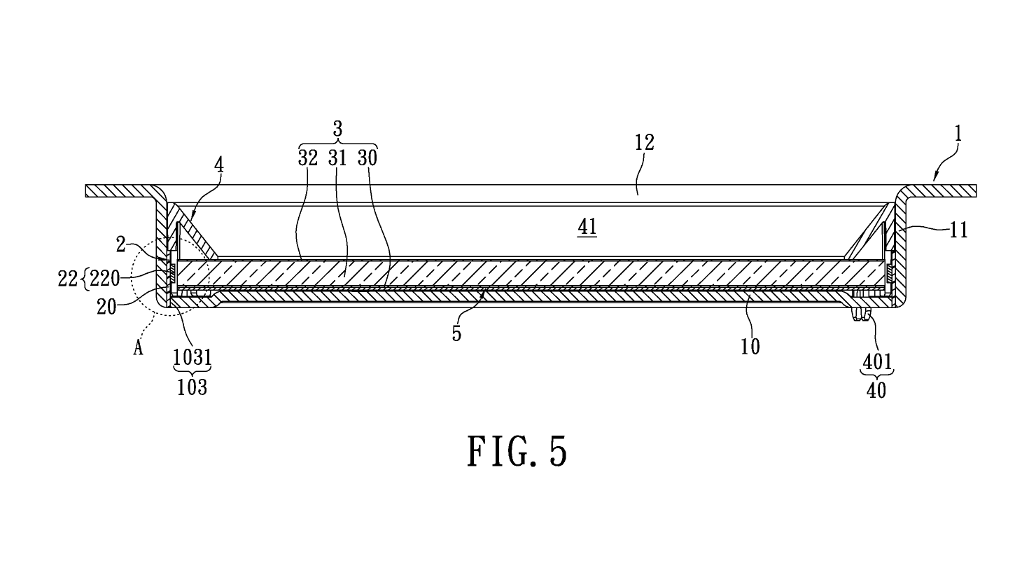

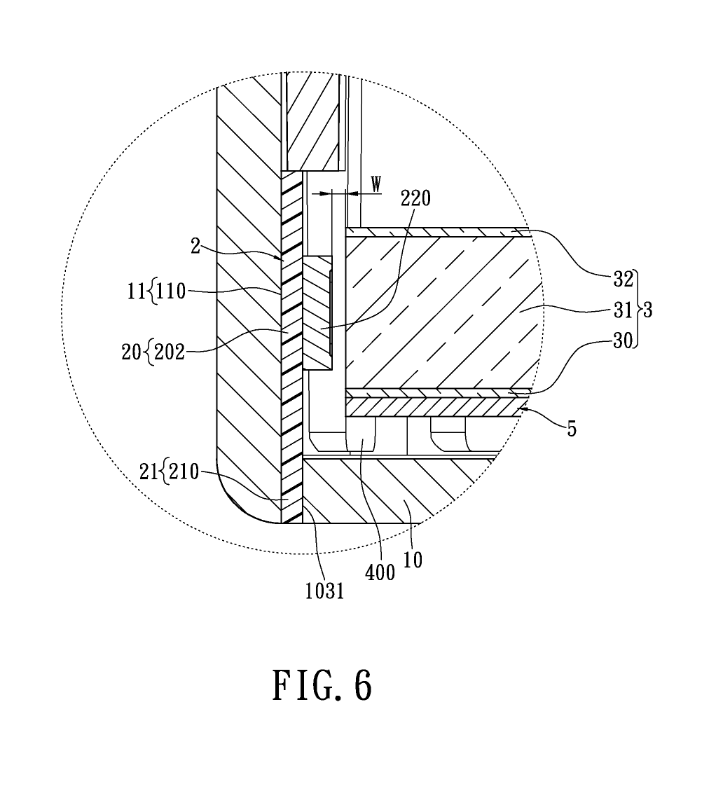

Please refer to FIGS. 5 and 6. FIG. 5 is a cross-sectional view of the illustrated embodiment, while FIG. 6 is an enlarged view of region A in FIG. 5.

The outer face 202 of the circuit board 20 substantially presses against the contacting face 110 of the side wall 11. Therefore, the heat generated by the light source module 2 can be conducted to the lamp housing 1. The lamp housing 1 can further dissipate the heat to the environment to provide an effective thermal management for the lamp structure.

The circuit board 20 has a projection portion 21. The projection portion 21 includes a plurality of tabs 210. The tabs 210 are identical in size and shape. The tabs 210 extend from one edge of the circuit board 20 and are spaced conformingly to the assembly slots 1031 of the bottom wall 10. In other words, the projection portion 21 is able to engage to the assembly slots 1031 through the tabs 210. By retaining the circuit board 20 in such manner, the light source module 2 is held securely in the lamp housing 1 in maintaining structural stability.

The light-guiding module 3 includes a reflection plate 30, a light-guiding plate 31, and a diffusion plate 32. The light-guiding module 3 is surrounded peripherally by the light source module 2. The reflection plate 30, the light-guiding plate 31, and the diffusion plate 32 are substantially circular in shape and have same diameters. The reflection plate 30, the light-guiding plate 31, and the diffusion plate 32 are stacked inside the receiving space 12. The light-guiding plate 31 and the diffusion plate 32 are transparent. The reflection plate 30 has a smooth surface to reflect the incident light to the light-guiding plate 31 and the diffusion plate 32 for light transmission.

More specifically, as better illustrated in FIG. 6, the edge of the light-guiding module 3 is held against a plurality of fastening arms 400 of the fastening piece 4. A gap W is created between the LEDs 220 and the light-guiding module 3. The gap W protects the LEDs 220 from being damaged by any movement of the light-guiding module 3. The light-guiding plate 31 is dimensioned (i.e., the thickness) to fully receive the emitted light by the LEDs 220.

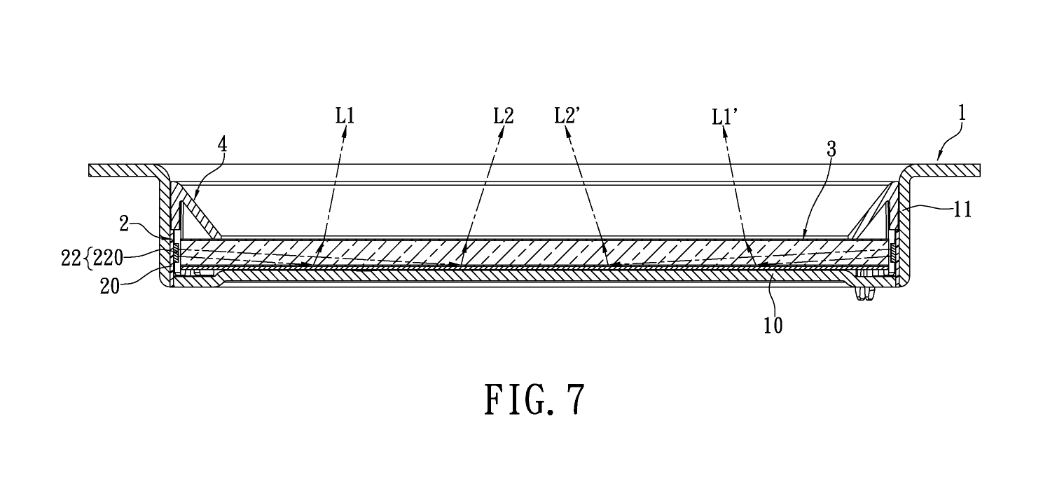

Please refer to FIG. 7 in conjunction with FIG. 6. FIG. 7 shows the light emitting paths of the lamp structure of the instant disclosure. As shown in FIG. 7, the LEDs 220 emit light rays L1, L1′, L2 and L2′ into the light-guiding plate 31. The light rays L1, L1′, L2, and L2′ are then reflected by the reflection plate 30 back to the light-guiding plate 31 and to the diffusion plate 32 for polarization refinement. The light continues to travel outward from the lamp housing 1 to provide excellent illumination effect.

Please refer back to FIGS. 3, 4, and 5. FIG. 3 shows the fastening piece 4 has a fastening portion 40 and an opening 41. The fastening portion 40 includes multiple fastening arms 400, which are elastic and extend from one edge of the fastening piece 4. The fastening arms 400 are abutted to the inner face 201 of the circuit board 20. Each of the LEDs 220 is arranged between two fastening arms 400. The opening 41 communicates with the receiving space 12 of the lamp housing 1. The fastening piece 4 partially presses against the contacting face 110 of the side wall 11. The fastening piece 4 also retains the light-guiding module 3 on the lamp housing 1 while holding the diffusion plate 32 exposed to the ambient.

Furthermore, the ring formed by the fastening arms 400 is slightly larger than the circuit board 20. Thus, when the fastening piece 4 is releasably engaged to the lamp housing 1, the elastic fastening arms 400 flex outward toward the circuit board 20. In such manner, the outer face 202 of the circuit board 20 is firmly pressed against the side wall 11.

Four of the fastening arms 400 are each fitted with at least one fastening hook 401. The fastening hooks 401 engage the respective receiving holes 100 for securing to the bottom wall 10. Hence, the fastening piece 4 firmly fixes the light source module 2 and the light-guiding module 3 to the lamp housing 1. To disassemble the lamp structure, the user only needs to disengage the fastening arms 400 from the bottom wall 10. The fastening piece 4 and the lamp housing 1 can thus be easily separated from each other. The above described configuration greatly facilitates the ease to assemble and dissemble the lamp structure.

Please refer to FIGS. 5 and 6. The lamp structure further includes a board 5. The board 5 is round and hard, preferably made of a non-transparent and temperature independent material. The board 5 is sandwiched between the light-guiding module 3 and the bottom wall 10. The edge of the board 5 is abutted to the fastening arms 400.

When the fastening arms 400 are deformed due to temperature change, the board 5 maintains a pressing force against the fastening arms 400 to retain the circuit board 20. Thus, the outer face 202 of the circuit board 20 remains substantially in contact with the contacting face 110 of the side wall 11. Excellent heat dissipation effect is maintained as well. However, the type of the board 5 is not limited to the example provided by the instant embodiment.

Please refer back to FIGS. 1, 2, and 3. The lamp structure further comprises a pair of connecting pieces 6. Each of the connecting pieces 6 has one attachment plate 60 and a handle 61. The attachment plate 60 has a connecting end 601 and defines a pair of locating holes 602. The handle 61 includes a holding portion 611 and an elastic body 612.

The elastic body 612 is spiral shaped and connected between two arms of the holding portion 611. The opposite ends of the elastic body 612 are connected to the connecting end 601 of the attachment plate 60. The connecting pieces 6 are fixed on the lamp housing 1 via the attachment holes 102 with screws. However, other fixing means may be employed as well.

For the illustrated embodiment, the lamp structure further comprises a driving circuit unit (not shown). The driving circuit unit is mounted to the underside of the bottom wall 10. The driving circuit unit is secured to the lamp housing 1 by the connecting pieces 6. The wires (not shown) of the light source module 2 pass through the wiring hole 101 and connects to the driving circuit unit. The type of the driving circuit unit is not limited to the example provided by the instant embodiment.

### Second Embodiment

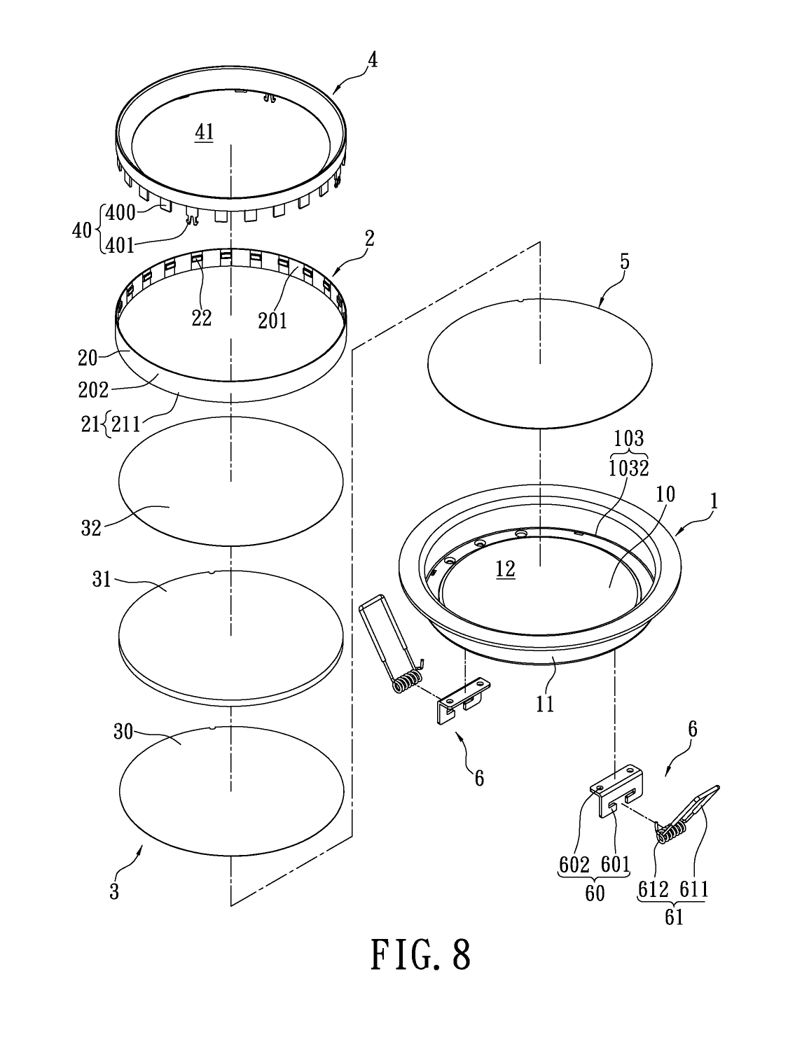

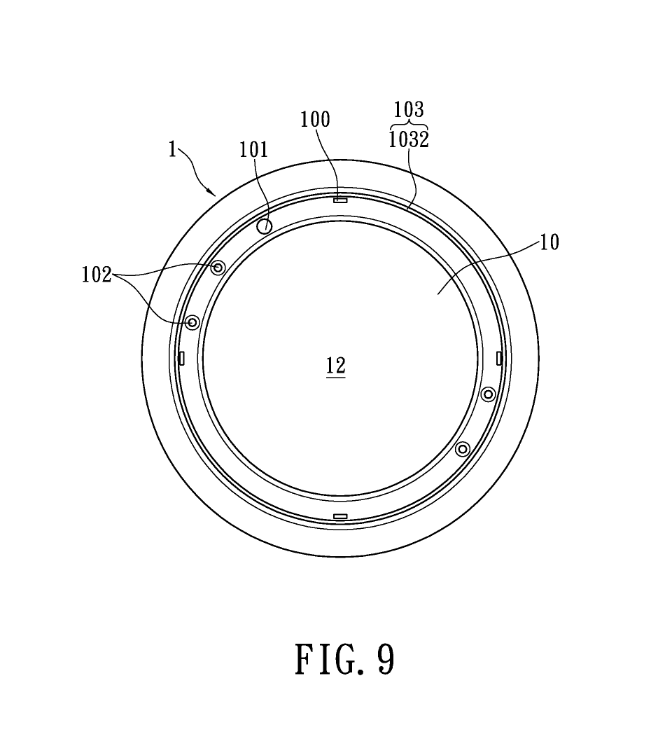

FIGS. 8 and 9 show a lamp structure for a second embodiment of the instant disclosure. FIGS. 8 and 9 are an exploded view and a top view of the lamp structure, respectively. The difference between the first and second embodiment is: the positioning portion 103 of the instant embodiment has a positioning slot 1032 instead of the assembly slots 1031 (as shown in FIG. 3). In addition, the circuit board 20 has an extension 211 integrally formed therewith and is without the tabs 210.

The positioning slot 1032 is an annular groove formed concavely on the bottom wall 10 without penetrating it. The extension 211 conforms in shape to and releasably engages with the positioning slot 1032 to secure the circuit board 20. The configuration of the positioning slot 1032 is not limited to the example provided by the instant embodiment.

Based on the foregoing, the lamp structure of the instant disclosure has the following advantages:

1. The utilization of positioning portion of the lamp housing and the projection portion of the circuit board for retaining the light source module provides better structural stability.

2. Excellent lighting quality is achieved for the LEDs via the light-guiding module.

3. The lamp structure can be assembled and disassembled with ease. The fastening piece presses against the light-guiding module and releasably locks it on the lamp housing. The fastening arms and hooks enable the fastening piece firmly attached to the lamp housing. The user can directly assemble and disassemble the fastening piece to and from the lamp housing quickly with ease.

4. The lamp structure provides a way of thorough heat dissipation which prolongs the life span of the lamp.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims

What is claimed is:

1. A lamp structure, comprising:
a lamp housing having a bottom wall, and an annular side wall, the bottom wall having a positioning portion and the side wall defining a receiving space;
a light-guiding module disposed in the receiving space;
a light source module surrounding the light-guiding module, the light source module having a circuit board and a plurality of light source units spacingly disposed thereon, the circuit board having a projection portion releasably engaged to the positioning portion; and
a fastening piece including a fastening portion releasably engaged to the lamp housing .

2. The lamp structure according to claim 1, wherein the positioning portion includes a plurality of assembly slots spacingly arranged on the bottom wall, and wherein the projection portion includes a plurality of tabs conforms in shape to and engages with the assembly slots.

3. The lamp structure according to claim 1, wherein the positioning portion includes a positioning slot, and wherein the projection portion includes an extension penetrating the positioning slot.

4. The lamp structure according to claim 1, wherein the fastening piece defines an opening, and wherein the light-guiding module is sandwiched between the fastening piece and the bottom wall, with the light-guiding module partially exposed via the opening.

5. The lamp structure according to claim 1, wherein the light-guiding module includes a reflection plate, a light-guiding plate, and a diffusion plate stacked sequentially in the receiving space, and wherein the fastening piece is abutted to the diffusion plate.

6. The lamp structure according to claim 5, wherein the fastening portion includes a plurality of fastening arms extending from an edge of the fastening piece and abutting the circuit board, and wherein the circuit board is abutted to a contacting face of the side wall.

7. The lamp structure according to claim 6, wherein the bottom wall defines at least one receiving hole, and wherein the fastening arms are elastic and at least one of the fastening arms has at least one of fastening hook penetrating the receiving hole and engaged to the underside of the bottom wall.

8. The lamp structure according to claim 7, wherein the fastening piece is partially abutted to the contacting face of the side wall, and wherein each light source unit is arranged between two adjacent fastening arms.

9. The lamp structure according to claim 1, further comprising a board disposed between the light-guiding module and the bottom wall, wherein and the edge of the board is held against the fastening portion.

10. The lamp structure according to claim 1, further comprising at least one connecting piece disposed on the lamp housing.
